(19) United States
(12) Patent Application Publication
(10) Pub. No.: US 2012/0304958 A1
(43) Pub. Date: Dec. 6, 2012

(54) IGNITION DEVICE

(76) Inventors: Werner Herden, Gerlingen (DE); Juergen Raimann, Weil Der Stadt (DE)

(21) Appl. No.: 13/513,747

(22) PCT Filed: Oct. 20, 2010
(86) PCT No.: PCT/EP10/65814

§ 371 Date: Aug. 21, 2012

(30) Foreign Application Priority Data
Dec. 9, 2009 (DE) 102009047700.4
Oct. 4, 2010 (DE) 102010041908.7

(51) Int. Cl. F02P 23/00; F02B 47/08

(52) U.S. Cl. 123/253

(57) ABSTRACT

A laser ignition device for an internal combustion engine includes a laser spark plug having a laser-active solid and an outlet window for a laser pulse, and an antechamber. Certain sections of the antechamber are delimited by the outlet window and the antechamber has at least one opening to a combustion chamber of the internal combustion engine. A blow-in device is provided, an outlet opening of the blow-in device ending in the antechamber.

### BACKGROUND OF THE INVENTION

1. Field of the Invention

The present invention relates to a laser ignition device for an internal combustion engine, a method for operating an internal combustion engine, a control and/or regulating unit and a computer program for such a method.

2. Description of the Related Art

The operation of internal combustion engines is presently implemented primarily with the aid of a high-voltage ignition via a mostly centrally located spark plug for igniting an air/fuel mixture. For this purpose, the so-called downsizing is increasingly used in combination with supercharging the internal combustion engine in order to achieve a reduction of the fuel consumption. Here, for the combustion, a stoichiometric air/fuel ratio (lambda=1) is strived for, since the already established three-way-catalytic converter technology for exhaust emission control may advantageously be used in this case, for example. However, the consumption reduction achieved by the downsizing is also the consequence of a so-called dethrottling, i.e., a reduction of the flow resistances in the intake ducts of the internal combustion engine.

This dethrottling in the intake ducts may also be improved by “diluting” the stoichiometric air/fuel mixture with exhaust gas. This process is referred to as exhaust gas recirculation (EGR). Using this process, the efficiency of the internal combustion engine may be improved. The exhaust gas recirculation has the side benefit that the combustion temperature and thus the untreated nitrogen oxide emissions decrease, which may possibly result in a reduction of the catalytic converter dimensions.

However, the dethrottling and exhaust gas recirculation concept also has disadvantages. Since high exhaust gas recirculation rates mean that the stoichiometric air/fuel mixture is diluted, the flame core formation and a sufficiently rapid combustion of the air/fuel mixture are thus made more difficult. To ensure reliable flame core formation, ignition systems having increased energy and ignition voltage must be used, for example. The sufficiently rapid combustion may, for example, be implemented with the aid of a flow increase (for example, by additionally switching on swirling flow and/or tumbling flow generators).

Another weak point of the downsizing concepts is the high ignition voltage requirement of the engines which are going to be supercharged to an increasingly greater extent in the future. The ignition voltage correlates with the closeness of the ignition point. Increasing the ignition voltage supply results in reduced reliability and, at the same time, in greater overall size and increased weight. Moreover, a large part of the energy stored in the ignition coil is needed in the case of high ignition voltages in order to charge the secondary capacities until the sparkover.

This energy correlates with the ignition voltage squared and may not be used for flame core formation, since it is converted into suppression and burn-off resistances. However, the increased current resulting therefrom generates an unwanted drastic increase in electrode burn-off which is increased even more during the so-called discharge phase of the spark due to the arc phases including melting of the spark points. In addition, in the case of high ignition voltages there is the risk of creeping discharges from the central electrode via the ceramic insulator into the plug housing, very likely resulting in spark trenches in the ceramic, and thus in spark failures.

In order to avoid the known disadvantages of the ignition by spark plugs at least partially, laser ignition devices have been developed which allow for a more flexible and reliable application.

A laser ignition device for igniting an air/fuel mixture in a combustion chamber in an internal combustion engine is known from published German patent application document DE 10 2006 018 973 A1, the laser ignition device protruding into the combustion chamber of the internal combustion engine. The laser ignition device includes an ignition laser which is optically supplied by a pumped light source using an optical fiber. Moreover, the laser ignition device has an essentially cylindrical antechamber which has multiple overflow passages for connecting the antechamber and the combustion chamber of the internal combustion engine. A generated flame core may exit the antechamber via the overflow passages and subsequently enter the combustion chamber in the form of torches which ignite the air/fuel mixture in the combustion chamber.

### BRIEF SUMMARY OF THE INVENTION

In order to be able to advantageously use the advantages of the previously described concepts in conjunction with the laser ignition device, the present invention differs from the related art mentioned at the outset in that a blow-in device is provided in the laser ignition device, an outlet opening of the blow-in device ending in the antechamber. The laser spark plug and the blow-in device are advantageously situated in a shared housing in this case. The blow-in device is designed as a controllable directional control valve and, when open, blows exhaust gas into the antechamber in a metered manner. In this way, the volume of the antechamber may be reduced in relation to the known laser ignition devices and may preferably be in the range of 0.5 cm³ to 2 cm³. This results in reduced installation space requirements and reduced manufacturing costs.

The present invention is furthermore based on the idea of forming a stoichiometric antechamber mixture using residual gas and blown-in exhaust gas, and to subsequently ignite and combust this mixture with the aid of the laser ignition device. Thus, an excess pressure is created in the antechamber in relation to the combustion chamber so that the air/fuel mixture of the combustion chamber is ignited reliably and rapidly by the torches emanating from the openings of the antechamber.

The layout of the antechamber ignition always takes place with the goal of the torches just not reaching the cylinder wall of the internal combustion engine. In this way, short flame paths occur during the combustion in the combustion chamber on the one hand, and the turbulence and thus the combustion rate are increased on the other hand. Both reduce the duration of the combustion (charge conversion) at a high exhaust gas recirculation rate and thus advantageously result in an increase of the thermodynamic efficiency.

As a result of the chemically driven intensification of the ignition in the form of torches in the combustion chamber, the antechamber may even combust extremely lean mixtures fast enough and, using this property, is by far superior to any conventional ignition system using spark plugs. This leads to substantial fuel savings but also to a reduction of untreated nitrogen oxide emissions.

In contrast to conventional high-voltage ignitions, the present invention distinguishes itself by a particular high-voltage resistance and a reduction of the installation space needed. An essential advantage of the laser ignition is also that the ignition takes place directly at the openings of an ignition place which has little residual gas, i.e., the antechamber, and ensures a reliable ignition. In addition, a very lean air/fuel mixture may be reliably ignited.

It is also advantageous that the at least one opening is situated radially and/or tangentially in a wall of the antechamber and/or centrically in a base plate of the antechamber which is directed toward the combustion chamber. During operation, the openings represent the connection between the antechamber and the combustion chamber and act as overflow bore holes for the air/fuel mixture, ignited in the antechamber, which enters the combustion chamber in the form of torches. Here, the geometric properties of the openings, such as the number, the position, the orientation and the cross section of the openings, have an influence on the form (torch length and torch width) and the flame direction of the torch. The number of the openings preferably ranges between three and seven openings; the number of the openings, as well as their orientation, and the geometric properties must be adjusted to the geometry of the combustion chamber.

In order to be able to use the present invention in the best possible manner, it is particularly advantageous that the exhaust gas quantity blown into the antechamber by the blow-in device is controlled as a function of an operating point of the internal combustion engine. The control preferably occurs via an engine characteristics map. The method necessary therefor is controlled or regulated by a control and/or regulating unit of the internal combustion engine. Due to the method and the geometric preconditions previously mentioned, it is possible to optimally adjust the torches necessary for igniting the air/fuel mixture in the combustion chamber to the instantaneous conditions during operation of the internal combustion engine.

The method is advantageously designed in such a way that exhaust gas is blown into the antechamber during operation after the exhaust-gas recirculation rate in the combustion chamber has fallen below a threshold value. The exhaust gas quantity blown into the antechamber is ascertained with the aid of the engine characteristics map as a function of the instantaneous operating point of the internal combustion engine. The engine characteristics map essentially establishes the correlation between the exhaust-gas recirculation rate in the combustion chamber and the exhaust-gas quantity blown into the antechamber. Here, additional operating parameters which influence the blown-in quantity may be taken into account, if necessary. The beginning of a compression phase of the internal combustion engine is preferably selected as the blow-in point in time. Due to the method, the antechamber is purged in a defined manner using the blow-in device so that following the ignition the pressure increase in the antechamber is reduced as a consequence of the resulting slower energy conversion therein, and the torch range in the combustion chamber is thus adjusted. This prevents the torch range of the torches, which emanate from the antechamber, in the combustion chamber of the internal combustion engine from being too far-reaching without exhaust-gas purging of the antechamber, thus accelerating the total conversion too excessively.

After the threshold value of the exhaust-gas recirculation rate in the combustion chamber has been exceeded, no exhaust gas is blown into the antechamber since the ideal torch range may be achieved in this case without exhaust-gas purging.

The present invention allows for a wide application range in motor vehicles since the length of the torches is controllable according to the present invention as a function of a load. This results in the fact that laser ignitions according to the present invention having antechambers are employable in almost all automobile applications.

However, it is also possible to use the present invention in other applications, for example, in stationary gas engines or heavy-duty gas engines, which are used for generating electrical current in particular, or in engines of this type which are used to drive any kind of machine or any kind of vehicle, in particular a ship.

During the acceleration phases or phases in which there is a transition between different load points, in particular, and/or when cranking an engine, in particular of a stationary machine or a ship, it is provided that a blow-in which differs from a blow-in provided in one or all stationary load condition(s), at least with regard to its composition and/or its blown-in quantity, is provided.

In addition to adjusting the blow-in or as an alternative thereto, it is also possible to provide, during the mentioned phases, a number of laser pulses per engine cycle which deviates from a number of laser pulses per engine cycle provided for one or all stationary load condition(s). In particular, more laser pulses per engine cycle may be provided during the mentioned phases than in one or all stationary load condition(s). It is also possible to provide multiple laser pulses per engine cycle per combustion chamber during the mentioned phases, only one laser pulse per engine cycle per combustion chamber being provided in one or all stationary load condition(s).

The specific adjustments of the blow-ins and the laser pulses take place in such a way that a torch length emanating from the antechamber is adjusted to, in particular made to match, the length of the combustion engine. Additionally or alternatively, it is possible to optimize an emission, in particular an NOx emission and/or a particle emission. It is also possible according to the present invention to optimize the ignition reliability during the mentioned phases, in particular when combusting a rich or, as compared to one or all stationary load condition(s), an enriched fuel/air mixture. In particular in stationary engines, enrichment of the fuel/air mixture is, however, also achievable with the aid of an appropriate blow-in, in particular during the mentioned phases.

### BRIEF DESCRIPTION OF THE DRAWINGS

FIG. 1a shows a schematic diagram of an internal combustion engine having a laser-based ignition device.

FIG. 1b shows a schematic representation of the ignition device of FIG. 1a.

FIG. 2 shows a detailed representation of an ignition device according to the present invention in a vertical section.

FIG. 3 shows a flow chart of the method.

### DETAILED DESCRIPTION OF THE INVENTION

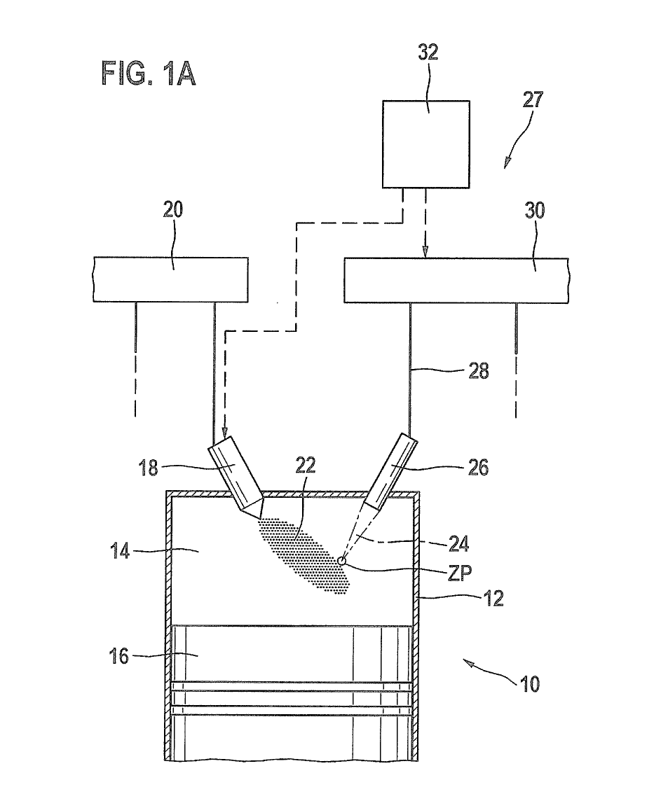

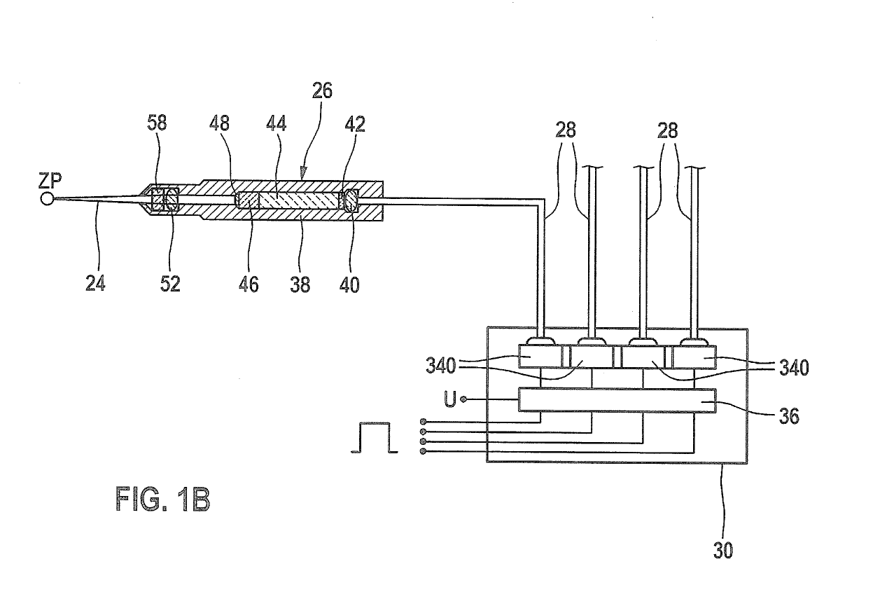

FIGS. 1a and 1b show the known surroundings of the present invention. An internal combustion engine is identified overall with reference numeral 10 in FIG. 1a. It may be used for driving a motor vehicle (not illustrated). Internal combustion engine 10 typically includes multiple cylinders, only one of which is identified by reference numeral 12 in FIG. 1a. A combustion chamber 14 of cylinder 12 is delimited by a piston 16. Fuel enters combustion chamber 14 directly through an injector 18, which is connected to a fuel pressure storage 20, also referred to as a rail. Alternatively, an air/fuel mixture may be formed outside combustion chamber 14, for example in an intake manifold (not illustrated).

Air/fuel mixture 22 present in combustion chamber 14 is ignited with the aid of a laser pulse 24 which is emitted into combustion chamber 14 by a laser ignition device 27 which includes a laser spark plug 26. The ignition in combustion chamber 14 may also be prepared in an antechamber (not illustrated in FIG. 1) situated upstream from the combustion chamber. Laser spark plug 26 is supplied, via fiber optic device 28, with pumped light which is made available by a pumped light source 30. Pumped light source 30 is controlled by a control unit 32 which is designed as a control and/or regulating unit and which may also activate injector 18.

As FIG. 1b shows, pumped light source 30 supplies multiple fiber optic devices 28 for various laser spark plugs 26, each of which is assigned to a cylinder 12 of internal combustion engine 10. For this purpose, pumped light source 30 has multiple individual pumped laser light sources 340 which are connected to a pulse current supply 36. Due to the presence of multiple individual pumped laser light sources 340, in a manner of speaking a “static” distribution of pumped light to the various laser spark plugs 26 is achieved, so that an optical distributor or the like between pumped light source 30 and laser spark plugs 26 is not necessary.

Laser spark plug 26 has, for example, a laser-active solid 44 having a passive Q-switch 46, which together with an input mirror 42 and an output mirror 48 forms an optical resonator. Acted upon by pumped light generated by pumped light source 30, ignition laser 26 generates, in a manner known per se, a laser pulse 24 which is focused by a focusing lens 52 onto an ignition point ZP located in combustion chamber 14 (or in a not illustrated antechamber). The components present in housing 38 of ignition laser 26 are separated from combustion chamber 14 (or the antechamber) by an outlet window 58 for laser pulses 24.

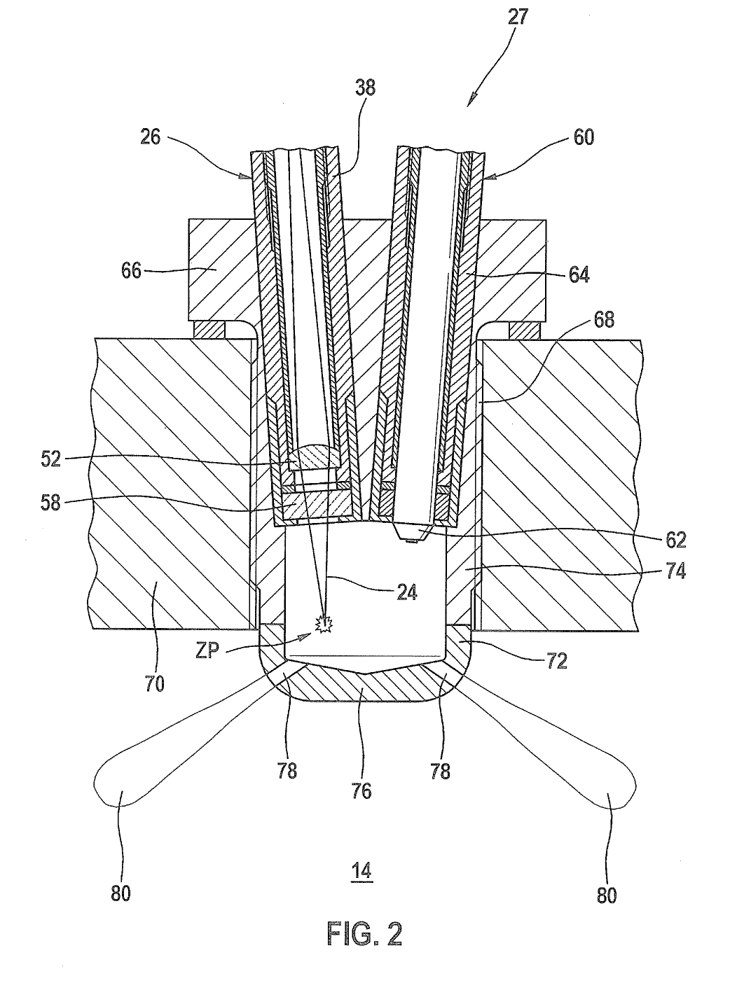

FIG. 2 shows a detailed representation of a laser ignition device 27 according to the present invention in a vertical section. Illustrated laser ignition device 27 includes laser spark plug 26 having outlet window 58 for laser pulses 24. Moreover, laser ignition device 27 includes a blow-in device 60 for exhaust gas which is situated separately and which is designed as a directional control valve controllable by a control unit 32. An outlet opening 62 is situated longitudinally on a free end of blow-in device 60. Blow-in device 60 has a separate housing 64.

Laser spark plug 26 and blow-in device 60 are integrated at an acute angle to one another into a shared housing 66, which is screwed into an opening of a cylinder head 70 of internal combustion engine 10 provided therefor using a thread 68. Alternative fastening possibilities such as using a bayonet joint or a clamping jaw are also possible.

Ignition point ZP of laser spark plug 26 lies in a cylindrical insert which is used as antechamber 72 for laser ignition device 27. Antechamber 72 is built into housing 68 or integrated into housing 68. Outlet opening 62 of blow-in device 60 also ends in antechamber 72. Thus, antechamber 72 is an integral part of laser ignition device 27 in addition to laser spark plug 26 and blow-in device 60.

Antechamber 72 includes a cylindrical lateral area 74, which is delimited downward by a base plate 76 in FIG. 2, base plate 76 having openings 78 in a marginal area which run obliquely downward relative to combustion chamber 14. Openings 78 may be situated radially and/or tangentially in walls 74 and 76 of antechamber 72 and/or centrically in base plate 76. Openings 78 may have an oblique or perpendicular orientation to lateral area 74 and base plate 76.

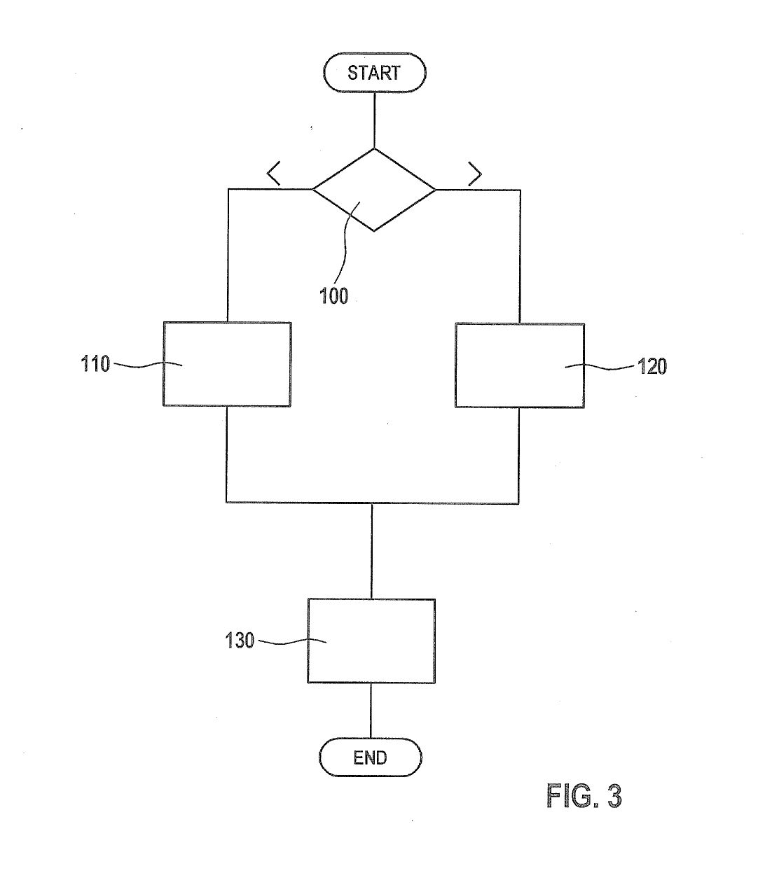

FIG. 3 shows in a flow chart the sequence of the method, the principal method for igniting an air/fuel mixture in a combustion chamber via a laser ignition device having an antechamber being assumed to be known.

In query 100, an exhaust-gas recirculation rate in combustion chamber 14 is ascertained and is compared to a threshold value stored in control unit 32.

If the exhaust-gas recirculation rate is below the threshold value, the exhaust gas quantity blown into antechamber 72 is ascertained in step 110 depending on an instantaneous operating point of internal combustion engine 10 with the aid of an engine characteristics map stored in control unit 32. The engine characteristics map essentially establishes the correlation between the exhaust-gas recirculation rate in combustion chamber 14 and the exhaust-gas quantity blown into antechamber 72. The beginning of a compression phase of internal combustion engine 10 is preferably selected as the blow-in point in time. Antechamber 72 is thus purged in a defined manner using blow-in device 60 so that following the ignition the pressure increase in antechamber 72 is reduced as a consequence of the resulting slower energy conversion therein, and the torch range is thus adjusted to combustion chamber 14.

If the exhaust-gas recirculation rate exceeds the threshold value, outlet opening 62 of blow-in device 60 is closed in step 120 so that no exhaust gas may flow into antechamber 70.

In this case, the ideal torch range may be achieved without exhaust-gas purging.

In parallel to step 110 or 120, fuel is also injected into antechamber 72. Moreover, an air/fuel mixture ascertained by control unit 32 is delivered according to known methods into combustion chamber 14, the air/fuel mixture being ignited in the power stroke of internal combustion engine 10 in a step 130 by igniting the antechamber load with the aid of ignited torches 80 emanating from openings 78.

1-11. (canceled)

12. A laser ignition device for an internal combustion engine, comprising:
a laser spark plug having a laser-active solid and an outlet window for laser pulses;
an antechamber having at least one opening to a combustion chamber of the internal combustion engine, wherein portions of the antechamber are delimited by the outlet window; and
a blow-in device having an outlet opening, wherein the outlet opening ends in the antechamber.

13. The laser ignition device as recited claim 12, wherein the laser spark plug and the blow-in device are situated in a shared housing.

14. The laser ignition device as recited in claim 12, wherein the blow-in device is configured as a controllable directional control valve.

15. The laser ignition device as recited in claim 12, wherein the blow-in device blows exhaust gas into the antechamber in a metered manner when the blow-in device is open.

16. The laser ignition device as recited in claim 12, wherein the at least one opening is situated at least one of (i) radially in a wall of the antechamber, (ii) tangentially in a wall of the antechamber, and (iii) centrically in a base plate of the antechamber which is directed toward the combustion chamber.

17. A method for operating an internal combustion engine, comprising:
providing a laser ignition device for the internal combustion engine, the laser ignition device including:
a laser spark plug having a laser-active solid and an outlet window for laser pulses;
an antechamber having at least one opening to a combustion chamber of the internal combustion engine, wherein portions of the antechamber are delimited by the outlet window; and
a blow-in device having an outlet opening, wherein the outlet opening ends in the antechamber; and
controlling, as a function of an operating point of the internal combustion engine, an exhaust gas quantity blown into the antechamber by the blow-in device.

18. The method as recited in claim 17, wherein the blown-in exhaust-gas quantity is controlled with the aid of an engine characteristics map.

19. The method as recited in claim 18, wherein exhaust gas is blown into the antechamber in a metered manner during operation after the exhaust-gas recirculation rate in the combustion chamber has fallen below a threshold value.

20. The method as recited in claim 18, wherein no exhaust gas is blown into the antechamber during operation after the exhaust-gas recirculation rate in the combustion chamber has exceeded a threshold value.

21. A control unit for a laser ignition device for the internal combustion engine, the laser ignition device including: a laser spark plug having a laser-active solid and an outlet window for laser pulses; an antechamber having at least one opening to a combustion chamber of the internal combustion engine, wherein portions of the antechamber are delimited by the outlet window; and a blow-in device having an outlet opening, wherein the outlet opening ends in the antechamber, the control unit comprising:
means for controlling, as a function of an operating point of the internal combustion engine, an exhaust gas quantity blown into the antechamber by the blow-in device;
wherein exhaust gas is blown into the antechamber in a metered manner during operation after the exhaust-gas recirculation rate in the combustion chamber has fallen below a threshold value; and
wherein no exhaust gas is blown into the antechamber during operation after the exhaust-gas recirculation rate in the combustion chamber has exceeded a threshold value.

22. A non-transitory computer-readable data storage medium storing a computer program having program codes which, when executed on a computer, performs a method for operating a laser ignition device for the internal combustion engine, the laser ignition device including: a laser spark plug having a laser-active solid and an outlet window for laser pulses; an antechamber having at least one opening to a combustion chamber of the internal combustion engine, wherein portions of the antechamber are delimited by the outlet window; and a blow-in device having an outlet opening, wherein the outlet opening ends in the antechamber, the method comprising:
controlling, as a function of an operating point of the internal combustion engine, an exhaust gas quantity blown into the antechamber by the blow-in device;
wherein exhaust gas is blown into the antechamber in a metered manner during operation after the exhaust-gas recirculation rate in the combustion chamber has fallen below a threshold value; and
wherein no exhaust gas is blown into the antechamber during operation after the exhaust-gas recirculation rate in the combustion chamber has exceeded a threshold value.
